(19) United States
(12) Patent Application Publication
(10) Pub. No.: US 2022/0019959 A1
(43) Pub. Date: Jan. 20, 2022

(54) System, Method, and Computer Program Product for Dynamically Interpreting, Learning, and Synchronizing Information to Help Users with Intelligent Management of Work

(71) Applicant: Hema Roy, Davie, FL (US)

(72) Inventor: Hema Roy, Davie, FL (US)

(21) Appl. No.: 17/443,106

(22) Filed: Jul. 20, 2021

Related U.S. Application Data
(60) Provisional application No. 63/053,852, filed on Jul. 20, 2020.

(51) Int. Cl. G06Q 10/06; G06N 5/04; G06Q 10/10

(52) U.S. Cl. CPC G06Q 10/063114; G06Q 10/103; G06N 5/045

(57) ABSTRACT

Systems, methods, and computer program products dynamically interpret, learn, and synchronize information to help users intelligently manage work and to improve project management tools. The system and method include receptors and interfaces for data exchange with user devices and modules that will connect, monitor, keep and present the data. Additionally, the user devices and modules monitor security and actions to be taken. A computerized nervous system with an artificial intelligence engine learns, applies, and evolves the method continuously. The system also includes storage of historical and ongoing management related data to enable projection algorithms to function and contribute to enterprise knowledge management and community intelligence. The systems and methods can be housed in external, internal, or hybrid clouds. The data exchanged can be in voice, video, text, or other formats, that are supported by current devices. The receptors/interfaces will transmit the data to and from the devices. The artificially intelligent engine and components allow for secure interaction with other systems and automation of management work.

### CROSS-REFERENCE TO RELATED APPLICATIONS

This application claims the benefit of U.S. Provisional Application No. 63/053,852, filed Jul. 20, 2020, which is hereby incorporated by reference.

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

The invention relates to methods for managing work, and more specifically to computer implemented systems, methods, and computer programs for project management and work management.

### Description of the Related Art

Management of work at today's workplaces is mostly a manual and cumbersome process. Work management is becoming increasingly complicated. Various management methodologies, experiences, and tools are in play.

Typically, organizations spend their time on a multitude of repeated manual management activities like creating and facilitating meetings; noting and following up on open action items; recording Portfolio, Plan, Progress, Product, Project, or Program (6P®); and managing other related data. The organizations use disparate tools to organize work. Then, the organizations try to report status or projections from these disparate tools to stakeholders, who make important decisions. At times, reports omit decisions and action items because there is no consistent means to record them. In addition, lack of regular tool updates or follow-ups can lead to failed work, wasted time, and wasted resources.

Organizations have used multiple, expensive, cloud-based, or self-created tools to manage work and to collaborate about it. Organizations use multiple tools because no one tool does it all. The use of multiple tools requires many managers or coordinators (i.e., “leaders”) to train to use all the tools to facilitate discussions and to assess status. The leaders might need the status and projections to prioritize enterprise work, gauge capacity utilization across teams, see global skill matrices, or view the enterprise's work in progress. No one tool gives the complete picture. As a result, leaders lack, wait for, or use incomplete versions of a total enterprise management “landscape” view when planning. In turn, this lack of a total view leads to poor decisions.

Nowadays, new management methodologies emerge, enterprises adopt new software development and IT operations (i.e., “DevOps”), change employees, and change in size. All these factors make the organization of work more difficult. In most organizations, the number of coaches, managers, and coordinators is greater than or equal to the number of actual execution staff. Such increase in staff leads to creation of layers, inefficiencies, and costs. An absence of proper facilitation, tool updates, follow ups, and monitoring of discussed plans can waste expensive travel costs associated with large, long-planning meetings. Additionally, gaps are seen in adoption of enterprise strategy governance processes as neither common understanding nor execution exists, which decreases data quality, leads to bad decisions, and wastes resources.

Managers, analysts, and coordinators interpret management methodologies differently. Different interpretations lead to varying techniques and usage of tools across teams in an organization. In turn, using different tools complicates consolidation into an overall status, thus impairing mangers' assessment of work in progress. Varying experiences and ideologies also can cause conflicts and failures in initiatives and compliance.

Statistics show that more than three quarters (>¾) of strategic initiatives fail due to either poor strategy or poor execution. The above factors (e.g., multiple changing management systems and use of multiple separate management tools) lead to both situations.

Users of existing management systems and tools update their different applications and continue to use tools that work with what they know about the ongoing work, without being able to retrieve, systematically or dynamically connected sensible information or recommendations. This inability leads to frustrating, manual processes to report work, which ultimately leads to poor decisions.

Therefore, there is a need for an intelligent solution to these problems that can connect and learn from the various tools logically and provide latest (i.e., up to date), complete, comprehensive, and data-based status and produce low-error recommendations to enable informed decision making for the upcoming work. In other words, no solution exists for solving problems of high costs of management along with ensuring the success rate of meeting enterprise strategic objectives.

A software bot is a type of software agent. A software bot has an identity and potentially personified aspects to serve its stakeholders. Software bots often compose software services and provide an alternative user interface, which is sometimes, but not necessarily conversational. Software bots are typically used to execute tasks, suggest actions, engage in dialogue, and promote social and cultural aspects of a software project. The term bot is derived from robot. However, hardware robots act in the physical world and software bots act in digital spaces. Some software bots are designed and behave as chatbots.

### Glossary of Terms

A “phase gate process” provides a baseline for teams to execute their projects. Having a set of standard tasks and deliverables guides teams in delivering projects. This establishes a clear standard of Project Management within an organization. The process acts as a platform for best practices for Project Management.

A mind map is a diagram used to visually organize information. A mind map is hierarchical and shows relationships among pieces of the whole. A mind map is often created around a single concept, drawn as an image in the center of a blank page, to which associated representations of ideas such as images, words and parts of words are added. Major ideas are connected directly to the central concept, and other ideas branch out from those major ideas.

A software bot is a type of software agent in the service of software project management and software engineering. Software bots are typically used to execute tasks, suggest actions, engage in dialogue, and promote social and cultural aspects of a software project.

### BRIEF SUMMARY OF THE INVENTION

An object of the invention is to provide a system, a method, and a computer program product for dynamically interpreting, learning, and synchronizing information to help users with intelligent management of work that overcomes the disadvantages of the systems, methods, and computer programs of this general type and of the prior art.

An object of the invention is to provide a method for a computer to make a computerized decision based on an input to a computer, a computer program running on the computer, and a computer-generated modification to the program that changes the computerized decision based on prior input and human-made decisions. The input (also referred to as incoming data) being considered is subject to a decision of an action, a recommendation, and/or a configuration of the system. Machine learning algorithms analyze prior inputs and apply configuration data and manual overwrites of the decisions being output by the computer program.

A further object of the invention is to provide a computer-hosted mind map by generating a virtual thread in which data describing an input is related to data describing the decision made by a machine learning modified computer program, and further relating that data to data describing an action taken in response to the input.

The method according to the invention can be performed in electronic circuitry, computer hardware, firmware, software, or in combinations thereof.

In accordance with the objects of the invention, a software bot is provided. The software bot (or just “bot”) is a software agent inspired by human managers. The software bot learns from monitoring users perform actions. Then, the software bot performs the same activities. The software bot can monitor speech for data, patterns, and experiences by recording the speech as an audio file, then converting the audio file to text using speech to text, then interpreting the text using natural language understanding and other industry-proven technologies to produce data describing the data, patterns, experiences in the speech. Next, the software bots correlate the data with actions initiated by the user and processed by applications other than the software bot on the system. Then, the software bot processes the data based on algorithms, which may or may not be proprietary. Using machine learning technologies, the software bot improves and learns from additional data, patterns, and experiences. As a result, the software bots mimic the actions previously taken after receiving matching data, patterns, and experiences by applying desktop and process automation technologies. In other words, the software bot replays automated or specified actions after receiving matching data (for example, data from text-to-speech or chat programs) with integrated machine learning algorithms. The software bot memorizes ongoing threads and patterns via recording various connecting and inferential data points and events across preselected integrated tools, for actions taken.

The described systems and techniques can be implemented in electronic circuitry, computer hardware, firmware, software, or in combinations thereof, such as the structural means disclosed in this specification and structural equivalents thereof. This can include a program operable to cause one or machines (e.g., a signal processing device including a programmable processor) to perform operations described. Thus, program implementations can be realized from a disclosed method, system, or apparatus, and apparatus implementations can be realized from a disclosed system, program, or method. Similarly, method implementations can be realized from a disclosed system, program, or apparatus, and system implementations can be realized from a disclosed method, program, or apparatus.

The invention includes a software bot. The software bot utilizes modern, cloud-based, opensource technologies. The software bot exploits machine learning and artificial intelligence to function. In a first step, a user provides data including a first datum and a second datum. The next step is connecting a first datum to a second datum. The next step is performing a function during setup. The next step is either adding a further function or modifying the (initial) function. Then, the method is repeated. As the adding or modifying step is repeated, the bot will evolve from assistants, which require outside assistance to run, to self-service devices, which run without outside assistance.

The method performed by the software bot can create a mind map for a piece of work (i.e., a or set of connections across systems). The piece of work includes a set of tasks outside or within a computer running a tool or application. The computer has an input from a human to interact with the tool or application. The software bot records human interaction and information to and from the tool or application. The software bot records ongoing interaction and information (i.e., input) and the software bot updates records and linkages in a database.

In accordance with the objects of the invention, a method can update application data based on user device output. A first step of the method is providing a receptor/interface for receiving user device output. The next step is connecting a core to the computer. The core hosts an artificial neural network. The next step is connecting a computer hosting a software tool to the core. The software tool stores application data. The next step is monitoring a relationship between an initial reception of the user device output and a change to the application data with the artificial neural network. The next step is transmitting a subsequent reception of the user device output received by the receptor/interface to the artificial neural network. The next step is transmitting an instruction from the artificial neural network to the software tool to enter the change to the application data after the artificial neural network decides the user device output is relevant. The next step is entering the change to the application data with the software tool when the software tool receives the instruction from the artificial neural network.

In the method according to the invention, the user device output can be chat text, computer input, an audio capture or audio capture recording, an online meeting recording, or virtual reality device data.

In the method according to the invention, the software tool can be project management software and the application data can describe a task of a project.

The method according to the invention can include reporting the change to the application data to a manager of the project.

The method according to the invention can include deleting the change to the application data when the manager decides to override the artificial neural network. A subsequent step is transmitting data describing a decision by the manager to override the artificial neural network to the artificial neural network. A subsequent step is changing the artificial neural network when the artificial neural network receives the data describing the decision by the manager.

The method according to the invention can include the step of transmitting the application data to the artificial neural network after changing the application data. A subsequent step is reporting to the manager when the artificial neural network determines the application data violates a requirement of the project. The artificial neural network creates the requirement based on a requirement found by sad artificial neural network in prior projects analyzed by the artificial neural network.

The details of one or more embodiments of the present systems and techniques are set forth in the accompanying drawings and the description below. Other features, aspects, and advantages will become apparent form the description, the drawings, and the claims.

Other features that are considered as characteristic for the invention are set forth in the appended claims.

Although the invention is illustrated and described herein as embodied in a system, a method, and a computer program product for dynamically interpreting, learning, and synchronizing information to help users with intelligent management of work, the invention should not be limited to the details shown in those embodiments because various modifications and structural changes may be made without departing from the spirit of the invention while remaining within the scope and range of equivalents of the claims.

The construction and method of operation of the invention and additional objects and advantages of the invention is best understood from the following description of specific embodiments when read in connection with the accompanying drawings.

### BRIEF DESCRIPTION OF THE SEVERAL VIEWS OF THE DRAWING

FIG. 1 is a schematic view of a computer system according to the invention.

FIG. 2 is a schematic view of the function of the computer system shown in FIG. 1.

FIG. 3 is a schematic view showing a configuration diagram of the computer program product and the components of computer program product core utilized for the same.

FIG. 4 is a schematic view showing an action diagram of the computer program product and the modules of computer program product core utilized for the same.

FIG. 5A is a schematic view showing the computer program product modules in action from end to end.

FIG. 5B is a schematic view showing the computer system.

FIG. 6 is a schematic view showing the computer system and its subsystems.

FIG. 7 is a schematic view of a computer according to the invention.

FIG. 8 is a flowchart of a method according to the invention.

FIG. 9 is a diagrammatic view of a display showing an input and output dialog of the system according to the invention.

FIG. 10 is a lane diagram showing a creating stakeholder map step of a method according to the invention.

FIG. 11 is a lane diagram showing a setting up calendar invites step of the method started in FIG. 10.

FIG. 12 is a lane diagram showing a noting and following-up step of the method started in FIG. 10.

FIG. 13 is a lane diagram showing a planning step.

FIG. 14 is a lane diagram showing a tracking step.

FIG. 15 is a lane diagram showing a capturing step.

FIG. 16 is a lane diagram showing a scope management tracking step.

FIG. 17 is a lane diagram showing an architecture/security management tracking step.

FIG. 18 is a lane diagram showing an automating step of the method.

FIG. 19 is a lane diagram showing a resource managing step of the method.

FIG. 20 is a lane diagram showing a 6P status displaying step of the method.

FIG. 21 is a lane diagram showing a financial management step of the method.

FIG. 22 is a lane diagram showing an incident, problem, and release management step of the method.

FIG. 23 is a lane diagram showing management presentation, dashboard, report steps of the method.

FIG. 24 is a lane diagram showing management drawings steps of the method.

FIG. 25 is a lane diagram showing management documents step of the method.

FIG. 26 shows an exemplary general-purpose computer that may be used for performing certain aspects of the invention.

### DETAILED DESCRIPTION OF THE INVENTION

The present invention is now described more fully hereinafter with reference to the accompanying drawings, in which embodiments of the invention are shown. This invention may, however, be embodied in many different forms and should not be construed as limited to the embodiments set forth herein; rather these embodiments are provided so that this disclosure will be thorough and complete and will fully convey the scope of the invention to those skilled in the art.

Like numbers refer to like elements throughout. In the figures, the thickness of certain lines, layers, components, elements or features may be exaggerated for clarity. Where used, broken lines illustrate optional features or operations unless specified otherwise.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements components and/or groups or combinations thereof, but do not preclude the presence or addition of one or more other features, integers, steps, operations, elements, components and/or groups or combinations thereof.

As used herein, the term “and/or” includes any and all possible combinations or one or more of the associated listed items, as well as the lack of combinations when interpreted in the alternative (“or”).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and claims and should not be interpreted in an idealized or overly formal sense unless expressly so defined herein. Well-known functions or constructions may not be described in detail for brevity and/or clarity.

It will be understood that when an element is referred to as being “on,” “attached” to, “connected” to, “coupled” with, “contacting,” etc., another element, it can be directly on, attached to, connected to, coupled with and/or contacting the other element or intervening elements can also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature can have portions that overlap or underlie the adjacent feature.

Spatially relative terms, such as “under,” “below,” “lower,” “over,” “upper” and the like, may be used herein for ease of description to describe an element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of over and under. The device may otherwise be oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only, unless specifically indicated otherwise.

It will be understood that, although the terms first, second, etc., may be used herein to describe various elements, components, regions, layers and/or sections, these elements, components, regions, layers and/or sections should not be limited by these terms. Rather, these terms are only used to distinguish one element, component, region, layer and/or section, from another element, component, region, layer and/or section. Thus, a first element, component, region, layer or section discussed herein could be termed a second element, component, region, layer or section without departing from the teachings of the present invention. The sequence of operations (or steps) is not limited to the order presented in the claims or figures unless specifically indicated otherwise.

The foregoing is illustrative of the present invention and is not to be construed as limiting thereof. The invention is defined by the following claims, with equivalents of the claims to be included therein.

A first embodiment of the invention is a system and computer program product that dynamically interprets, learns, and synchronizes information to help users with the intelligent management of work. The first embodiment includes a plurality of methods.

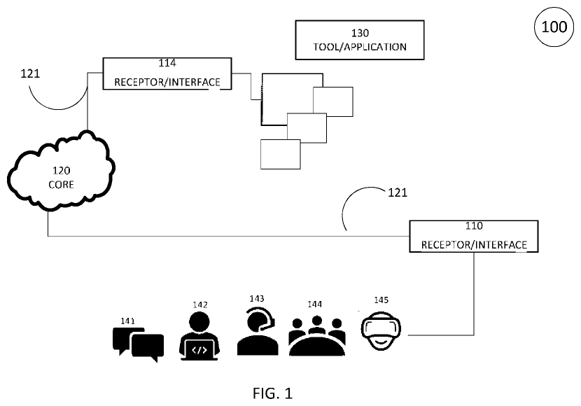

FIG. 1 shows a preferred embodiment of a system 100 for performing the methods of the invention. In the system 100, user device output (e.g., a chat 141 with a user; computer input 142 from a keyboard, mouse, or the like; an audio capture 143 from a microphone or voice call recording; an online meeting or online meeting recording 144 from videoconference software, or virtual reality device data 145 describing a virtual reality environment and a user's interaction with the environment) connects to a receptor/interface 110. The receptor/interface 110 is a shared boundary across which two or more separate components of a computer system exchange information. The exchange can be between software, computer hardware, peripheral devices, humans, and combinations of these. Some computer hardware devices, such as a touchscreen, can both send and receive data through the receptor/interface 110, while others such as a mouse or microphone may only provide an interface to send data to a given system. The receptor/interface 110 is connected to a telephone and/or computer network 121 (also referred to as, “Network 121”) or bus. While FIG. 1 shows the receptor/interface 110 interconnecting the examples of user device output, in other embodiments, which are not shown, each source of user device output could have its own respective receptor/interface. A core is 120 is connected to the network 121. A preferred embodiment of the core 120 is a computer server is located in the cloud and includes the following components: a network interface, a microprocessor for running computer programs, and data storage. The data storage stores applications that are executed on the microprocessor and further stores data that is to be used by the application run on the microprocessor. The microprocessor transmits data through the network interface and then to and from the network 121. The core 120 is connected by a network 121 to a receptor/interface 114 of a tool/application 130.

A preferred embodiment of a method can be performed on the system 100. By listening to the user device output (e.g., a chat 141, computer input 142, audio capture 143, online meeting or online meeting recording 144, and virtual reality device data 145) sent from the user or user devices, determining, using a microprocessor in the core 120, whether to 1) take action for a user, 2) process the user input with an artificial intelligence (AI) engine if a nervous system response is needed, or 3) update the artificial intelligence engine/computer program product if a configuration entry is needed.

A core 120 is a computer for performing all activities of the computer program product including saving memory snapshots. A memory snapshot is a set of data describing a status of each tool/application 130 at a given moment. The core 120 is connected to the computer network 121.

A second embodiment of a method involves connecting a user or a set of users with a computer network 121 via the tool/application 130 used by the user. Examples of preferred embodiments of the tool/application 130 include a chat with a user, a computer input device, a microphone, a videoconference application, and a virtual reality device. And, based on the user device output, determining using a microprocessor in the core 120, whether to act for a user or to create/update a configuration entry if a nervous system response is needed, based on artificial intelligence (“AI”) engine processing of the user device output.

In at least one embodiment, there is a step of memorizing the data being processed by the bot program.

In at least one embodiment, there is step of formulating a response to the input.

For every action taken by the bot to update the tool/application 130 or for every stream of data going through the core 120, the core 120 maintains a logically-linked metadata map in a database in the cloud. The logically linked metadata map includes basic audit fields. Along with the basic audit fields, the logically-linked metadata map includes but is not limited to input, user information, data about the tool/application 130 being updated, a connection key to the tool/application 130. The logically-linked metadata map also will maintain the logical inference/tag of the step recorded. Customization using the mind map is possible to include actual data sets and memory snapshots from the tool/application 130 and input channels; as needed to make algorithms more intelligent.

The bots running in the core 120 coordinate, record, and follow up on the user device output, while also meaningfully updating the tool/application 130, and keeping the disparate data points, meaningfully integrated. The intelligently linked data is available in the cloud and can be used anytime. Live and consolidated status can be provided to pre-defined stakeholders, in real time, at granular or aggregated level, enabling better decision making. Intelligently linked data means, for every action taken by the bot, updating tools/applications, streams of data, or inputs going through the core 120 will maintain a linked meta data map in a database in the cloud. Along with having basic audit fields (including but not limited to updated date, updated time, updated by, requested by, tools/applications updated, connecting key across the tools/applications updated) the linked meta data map also maintains the logical connection including but not limited to input type, action type, action invoked, and net impact on the thread.

Using ongoing and past data points, lessons learned and retrospectives, the bots can predict, forecast, alert, recommend outcomes and management execution approaches.

These bots automate repetitive manual processes and tasks and adjust them to meet needs over time, while also meaningfully aggregating relevant data points.

Organizational processes and guidelines can be input, and these bots can interactively assist with compliance to the same, enabling successful audits.

The bots can respond to user queries via text or voice. These can provide alerts or notifications, as needed.

Data available will be used securely to create a management community for learning and collaboration across organizations to allow for overall industry success. Experiences shared by experts will be used to enhance the bot's algorithms. As methodologies change, the logic used in the bots can be tuned to adopt best practices and lessons learned from new methodologies.

The capabilities of the bots will evolve overtime to allow self-serviceability by the bots.

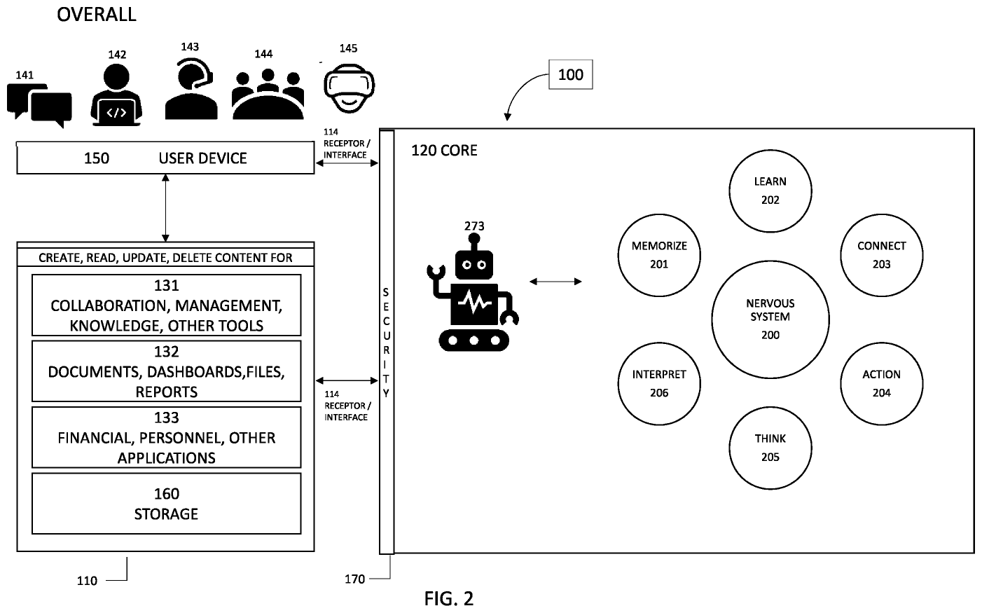

FIG. 2 shows functions of the computer system 100. A user device 150 generates user device output. Examples of the user device output include chat with a user 141, the computer input 142, and the audio capture 143, the online meeting recording 144, and the virtual reality device data 145. The receptor/interface 110 is connected to the following: collaboration, management, knowledge, other tools 131; documents, dashboards, files, and reports 132; financial, personnel, and other applications 133; and storage 160. Receptor/Interface 114 interconnects the user device 150 and the core 120. Receptor/Interface 114 interconnects the receptor interface 110 and the core 120. The core 120 has a security layer 170. The core 120 has a nervous system 200. The nervous system 200 performs the following functions: memorize 201, learn 202, connect 203, action 204, think 205, and interpret 206.

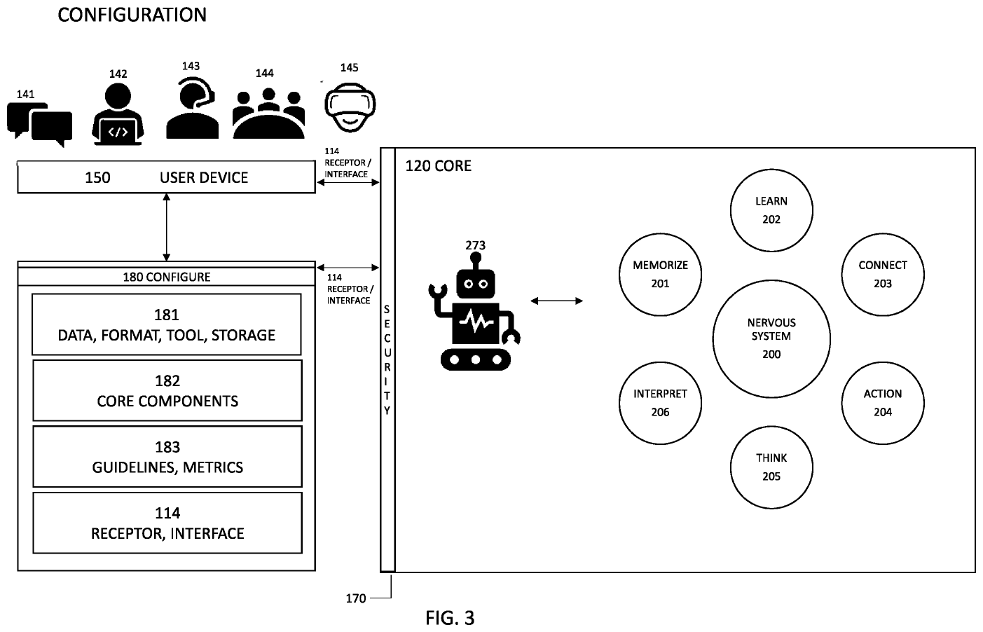

FIG. 3. shows a configuration diagram of the computer program product 180 and the components of computer program product core 120 utilized for the same. The computer program product 180 includes a data, format, tool storage map 181, core components 182, guidelines and metrics 183, and receptor/interface 114. The user device 150 is connected to the computer program product 180. Receptor/interface 114 interconnect computer program product 180 and core 120.

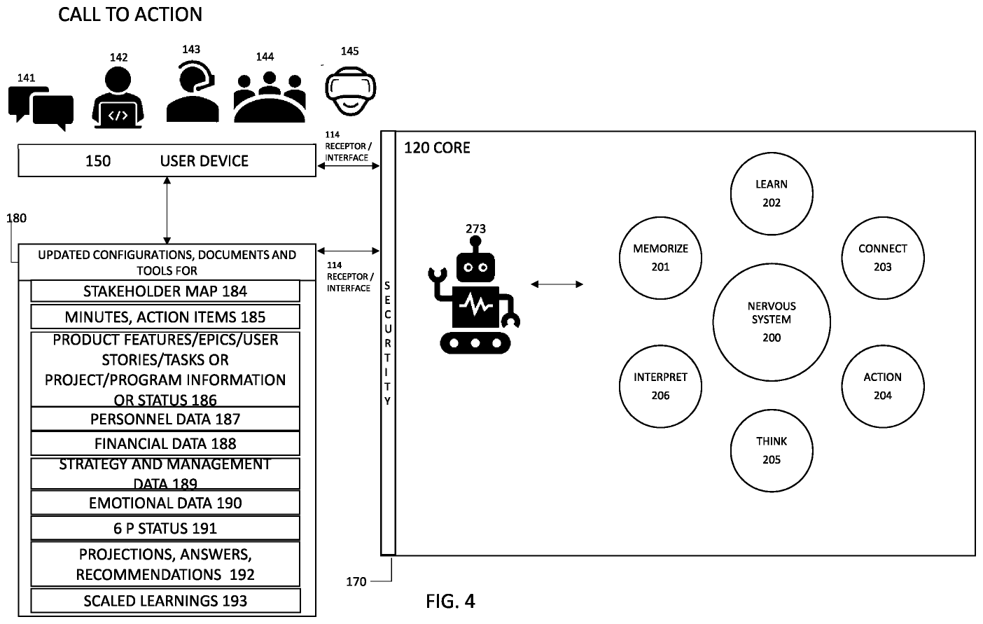

FIG. 4. shows an action diagram of the computer program product 180 and the modules of computer program product core 120 utilized for the same. The computer program product 180 includes the following modules: a stakeholder map 184; minutes and action items 185; product features/epics/user stories/tasks or project/program information or status 186; personnel data 187; financial data 188; strategy and management data 189; emotional data 190; 6 P Status 191; projections, answers, recommendations 192; and scaled learnings 193.

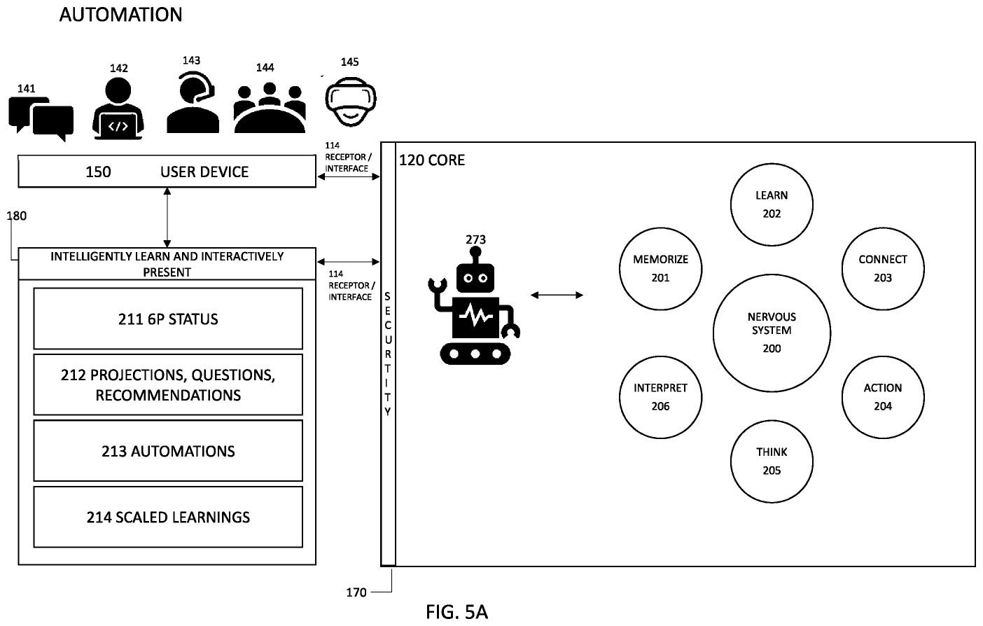

FIG. 5A shows the computer program product module 180 in action from end to end. User device output from user device 150 (e.g., the text message 141, the computer input 142, the audio capture 143, the online meeting recording 144, and virtual reality device data 145) are connected via interceptor/receptors 114 to the core 120. The computer program product 180 receives the user device output from the user device 150. The computer program 180 intelligently learns and interactively presents 6P® status 211; projections, questions, and recommendations 212; automations 213; and scaled learnings 214. Receptors/interfaces 114 interconnect the computer program product 180 and the core 120. In the core 120, the nervous system 200 is programed to memorize 201, learn 202, connect 203, act 204, think 205, and interpret 206.

FIG. 5B shows the computer program product 180 receiving user device output 151 from the user device 150 (which are not shown in FIG. 5B). The user device output 151 is sent on a computer network or bus through the security module 230. The interpret module 240 receives the user device output 151 and generates decisions based on an algorithm. The computer program product 180 receives a decision from the interpret module 240. The computer program product 180 includes an action module 251; a memorize, learn, and think module 252; a connect module 253, and a security module 254. The action module 251 performs Create, Read, Update, delete actions on applications and tools based on the algorithms and user interaction or automation. The think module 252 checks the algorithms and data to make recommendations or make decisions. The think module 252 also enables continuous learning by passing any overrides or feedback information back to the nervous system that hosts the algorithms. The connect module 254 (i.e., mind map) keeps an entry for every input, action, tools used, output, inference at a meta data level to ensure all threads for 6P are connected. The security module 230 ensures that the end-to-end functionality and data is available securely. The computer program product 180 outputs actions and/or recommendations to a user device 260 hosting a software application. The user uses device 260 to send feedback regarding the output and transmits closure or no response or override to the computer program product 180.

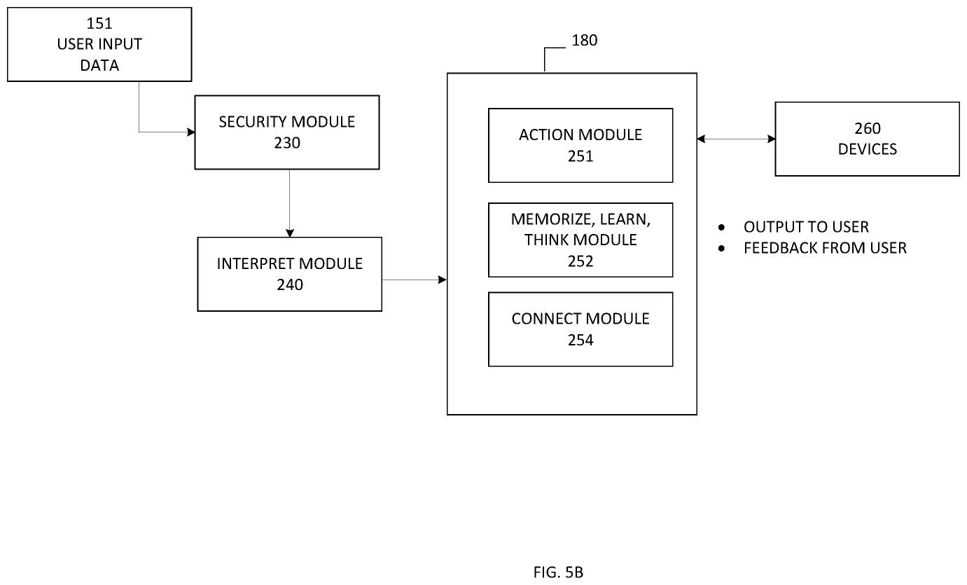

FIG. 6 shows a computer system 100 hosting the computer program product, which is not shown in FIG. 6. Embodiments of user devices including a computer 101, a tablet computer 103, a smartphone 102, and an Augmented Reality/Virtual Reality device 104 are connected to a receptor/interfaces 110 of tool/application 115. The receptor/interface 110 passes data from the tool/application 115 to the computer system 100. The computer system 100 includes an interpret module 240. The interpret module 240 sends/receives data to/from algorithms implementation and database of training data 271. The database of training data 271 uses the algorithms implementations and sends a decision to the interpret module 240. The database of training data 271 is further connected to the processing module 255. The processing module 255 receives data from the database of training data 271 and sends data to the database of training data 271. A database of Configurations, Actions, and Security data containing available configurations, actions, and security features data is connected to the processing module 255. The Mind Map or the Connect Data containing metadata based linkages, memory snapshots, tagged logical inference among others is connected to the processing module 255 and the other databases. The processing module 255 sends performs actions on the tool/application 115, and software bots 273.

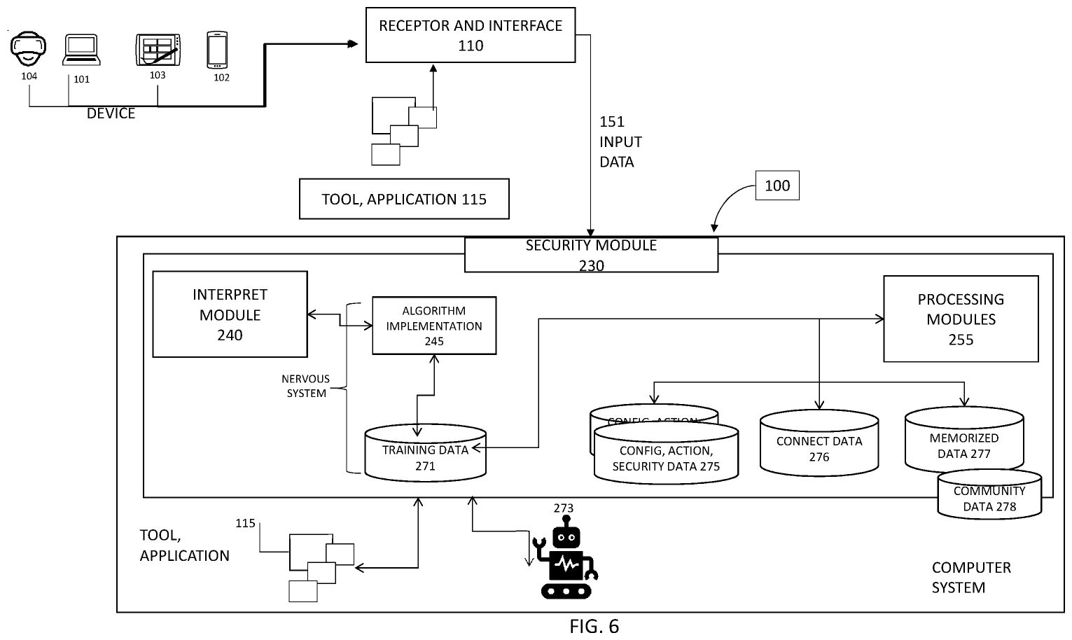

FIG. 7 shows a preferred embodiment of a computer system 100. The computer system 100 includes an audio, video, action input 140 for receiving data. An input and output 146 sends and receives data and actions. The computer system 100 includes memory 147, a microprocessor 148, receptors and interfaces 110, storage 149 for computer-readable data, and a power supply 152.

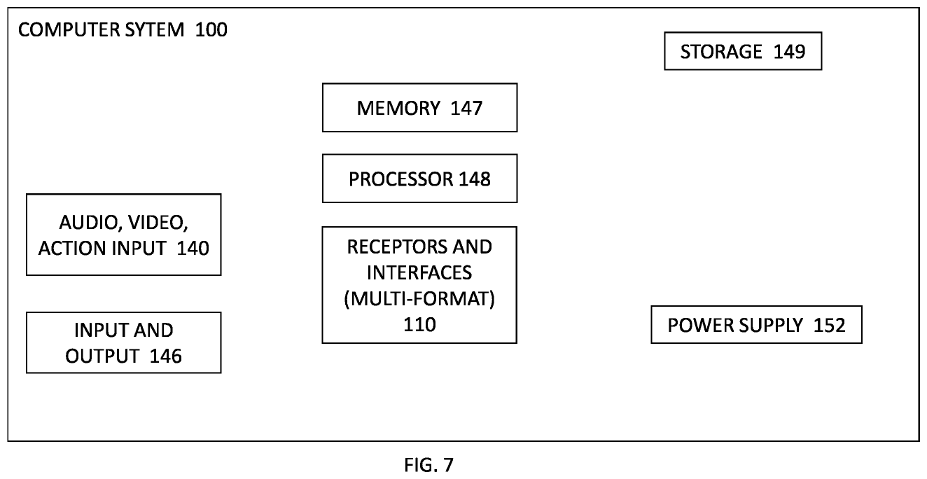

FIG. 8 is a flowchart of a preferred embodiment of the invention. In a first step, a user provides user device output 151 user device output 151. In the next step, the user device output 151 is passed to an application 282. In an interpreting step 300, the computer program product converts the user device output 151 into a computer readable form: for example, by converting speech to text, interpreting, and learning. In a configuration action request step 301, the computer program product determines if the input data 141 is a configuration request. If the user device output 151 is a configuration request, then, in configuring step 302, the computer program product enables users to configure the computer program product. If the user device output 151 is determined not to be a configuration request in configuration action request step 301, in action request step 303, the computer program product determines if the user device output 151 is an action request. In an acting step 304, the computer program product performs CRUD or acts on required tools and applications and listens for user feedback. If the computer program product determines that the input data 140 is not an action request in action request step 303, then, in thinking inquiry step 305, the computer program product determines whether the user device output 151 requires thinking. If the computer program product determines that the user device output 151 requires thinking in thinking inquiry step 305, then, in a thinking step 306, the computer program product performs analyzing and acting intelligently on the user device output 151 and the computer program product awaits user feedback. If the computer program product determines that the user device output 151 does not require thinking in the thinking inquiry step 305, then, in memorizing step 307, the computer program product saves the user device output 151, and the actions 302, 304, 306. The computer program product saves the user device output 151, and the decision, and the actions 302, 304, 306 in all other cases, as well. In output/sync step 308, following steps 302, 304, 306, and 307, the computer program product provides output and synchronizes connections to applications 282. The user device output 151 could be determined to be either one or more of the action, configuration, thinking requests. The core 120 is where the computer program product runs and executes the above-described method steps.

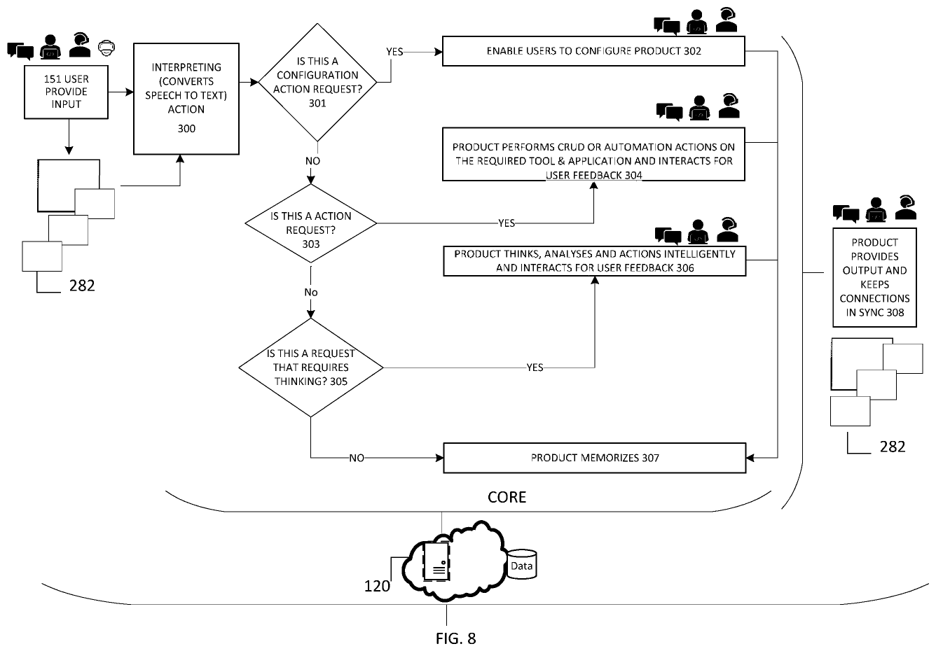

FIG. 9 illustrates a dialog between a user 310 and a computer program product 180. The user 310 submits a query 311; the computer program product 180 replies with response 312. The user 310 submits a query 313; the computer program product 180 replies with response 314. The user 310 submits a query 315; the computer program product 180 replies with response 316. The user 310 submits a query 317; the computer program product 180 replies with response 318.

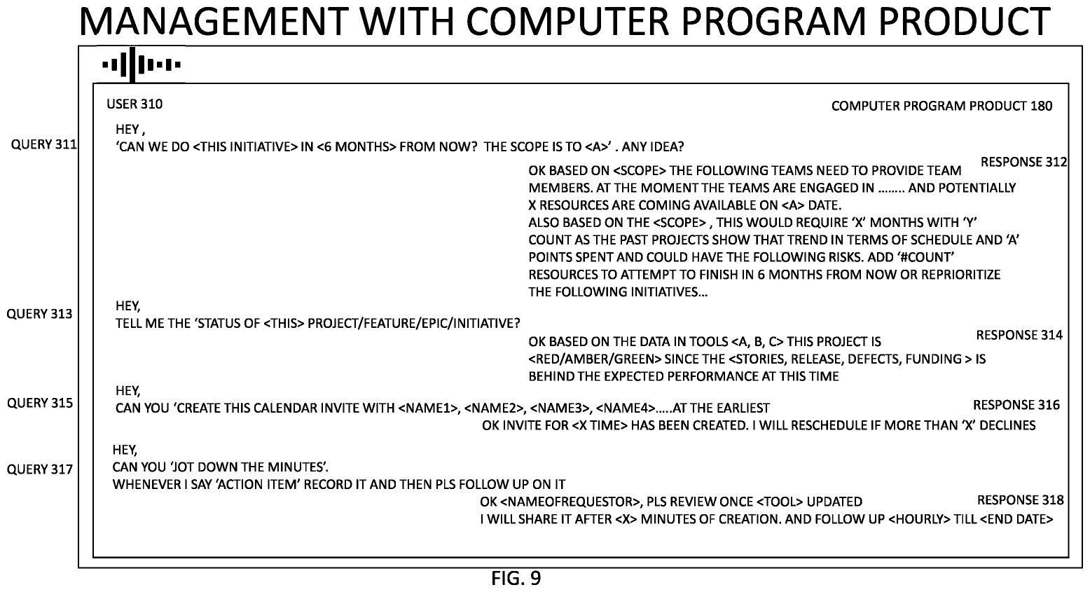

FIGS. 10-25 are lane diagrams showing the status of the tool/application 115, computer program product 180, stakeholders, and product configuration at the different steps of the method. A line diagram, which can also be referred to as a swim lane diagram is a process flowchart that allows one to visually distinguish duties and responsibilities, as well as sub-processes within these business processes. Like other flowcharts, lane charts visualize a process from beginning to end, using the metaphorical lanes of an actual swimming pool to place the steps of mapping the lanes either vertically or horizontally. A lane diagram is typically used for projects that extend over various departments and distinguishes channels according to a specific set of objectives. By organizing the responsibilities in various directions, a lane diagram can clearly distinguish the objective of each department and individuals inside the team.

FIG. 10 shows a creating stakeholder map. The product configuration lane 501 includes the steps of 320 connecting with the tool to be used for mailbox, workspace managements; 321 connecting with call tools and email distribution (if applicable); 323 connecting with any organization people management tool providing name, location, email id, and hierarchy; and 324 selecting the tool in which the output stakeholder map is expected. The stakeholders lane 502 includes the step of 325 talking with stakeholders about roles, names, hierarchies for an initiative, program, or governance structure, etc. The computer program product lane 503 includes the steps of 326 listening to calls and automatically setting up the stakeholder map with names, project roles, location, email id, and contact number; 327 prompting for roles and primary/secondary offline roles if the roles were not caught and confirming the roles that were caught; 328 automatically updating roles over calls; 329 updating role changes; and 330 learning, memorizing, maintaining connections, maintaining mind map. The applications/tools lane 504 includes the step of 331 updating the applications/tools.

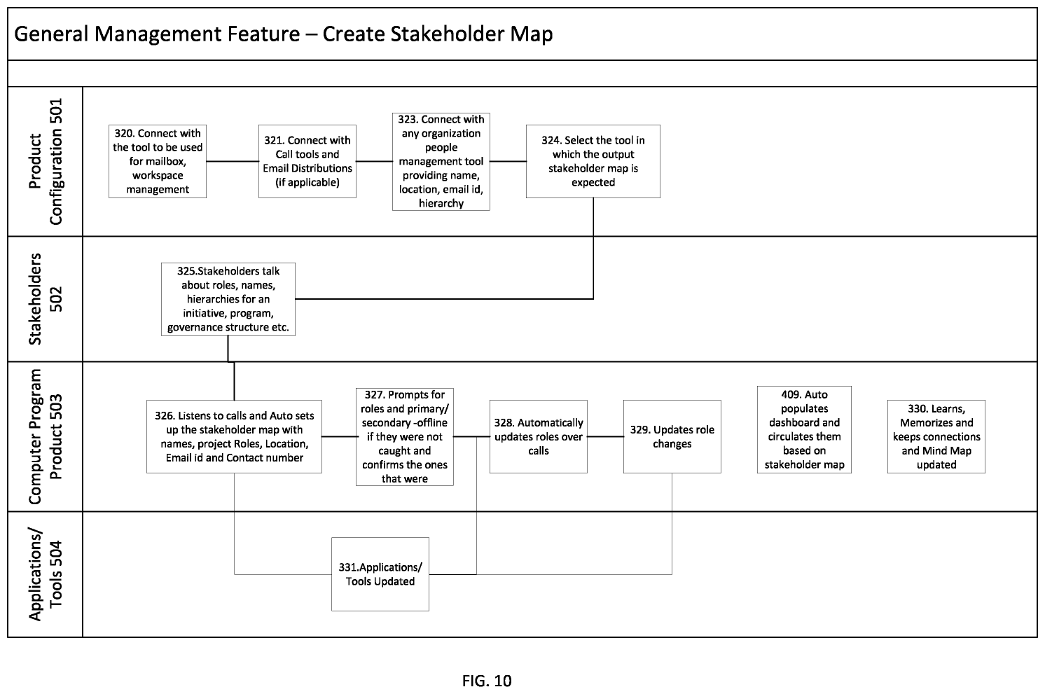

FIG. 11 shows a method for creating calendar invites. The product configuration lane 501 includes the steps of 332A selecting the tool to be used for mailbox integration for the users; 3326 providing project, initiatives, epics, and work names; 333A selecting the time zone preferences for the calls; 333B dragging and dropping stakeholder list (with primary/secondary names) for a project and the locations and tagging them as technology, architecture, or business by using a stakeholder map created by the computer program product; 334 providing the number of rejections threshold or invites or subject prioritizations to determine rescheduling. The stakeholders lane 502 includes the step of 335 requesting stakeholders for future call or discussing a call cadence and reason for the call cadence. The computer product lane 503 includes the steps of 336 setting up the calls with the tagged stakeholders at the earlies time window prescribed and specifying subject line based on tagging that chosen or heard; 337 allowing users to review/update invites; 338 searching for conflicts within a week and asking for deprioritzation of other calls; 339 rescheduling when more than a given number of rejections are found; and 330 learning, memorizing, maintaining connections, and maintaining mind map. The applications/tools lanes 504 shows the step of 331 updating applications/tools.

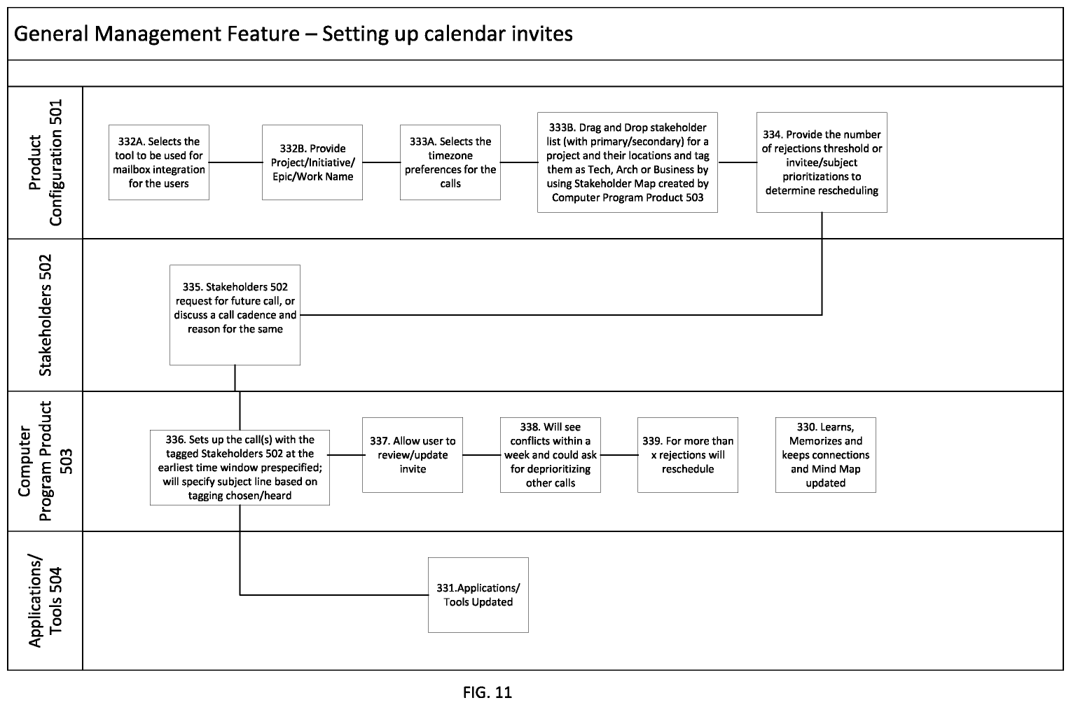

FIG. 12 shows a method for noting actions, risks, and issues and making follow ups (i.e., reminders) to close method. The product configuration lane 501 includes the steps of 341 selecting the tools to be used for recoding minutes; 342 providing project, initiative, epic, and work names; 343 selecting the tools with which to integrate calls; 344 selecting shareholders from a list (for example, by dragging and dropping), locating the stakeholders, and tagging the shareholders as technology, architecture, or business or product owners; and 345 specifying which tool is to be used for action item circulation. The stakeholders lane 502 includes the step of 346 discussing the action items, risks, and issues among others. The computer program product lane 503 shows the steps of 347 recording spoken work on the mention of action item, logging the items in an action item format, logging risks, issues as they are identified, and prompting for assignees, due dates, impact, and probability fields; 348 sharing the action item logs by tagging attendees/owners or sending an email to the attendees/owners; 349 following up until action items, risks, issues are closed; and 330 learning memorizing, and maintaining connections, and maintaining the mind map. The applications/tools lane 504 shows the steps of 350 updating actions, assigning risks, and assigning issues; and 351 recording minutes as action items are called out.

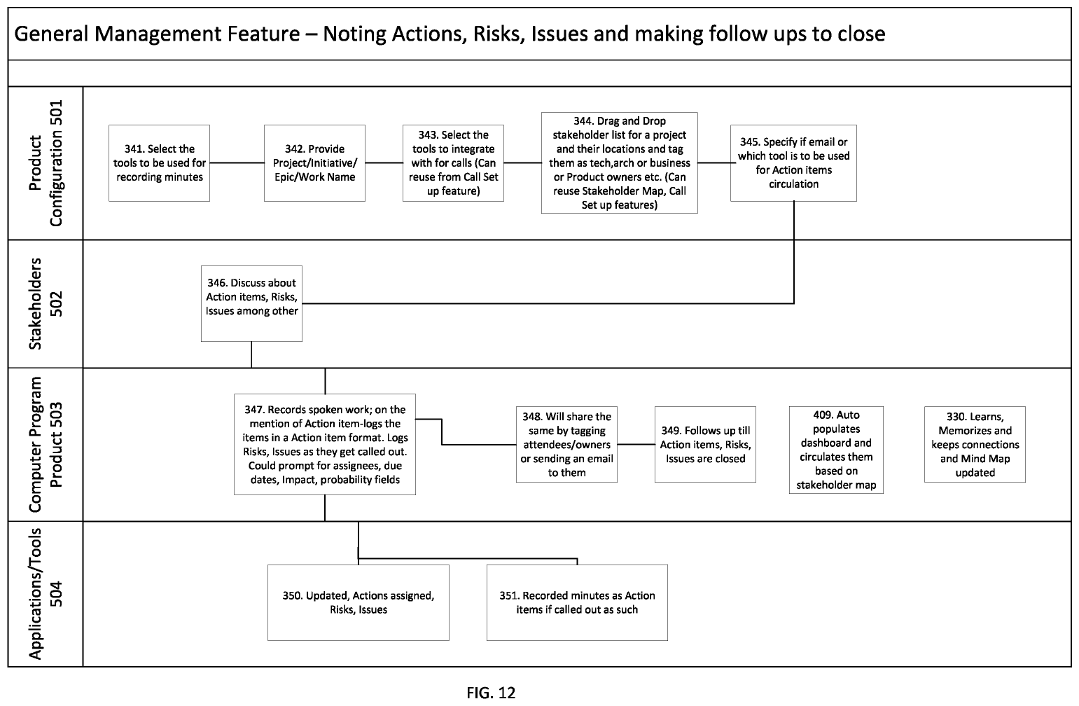

FIG. 13 is a lane diagram illustrating a preferred embodiment of a planning method. The product configuration lane 501 includes the steps of 352 connecting with the software development lifecycle or management methodology and/or tool to be used; 353 selecting the format in which the plan is required and call tool and destination folder; 354 processing the documents, deliverables that need to be generated as phase gate deliverables per compliance per chosen methodology; 355 connecting with the key roles and stakeholder map. The stakeholders lane 502 includes the following step: 356 envisioning, discovering, planning, and replanning discussions. The computer program product lane 503 includes the following steps: 358 Outputting template that includes key user stores and tasks identified from the calls; 357 prompting for checks offline; 359 publishing the template by tagging attendees or sending an email to the attendees; 360 creating a timeline (e.g., a Gantt chart view of the plan); and 330 learning, memorizing, maintaining connections, and maintaining the mind map. The applications and tools lane 504 include the step of 331 updating the applications and tools.

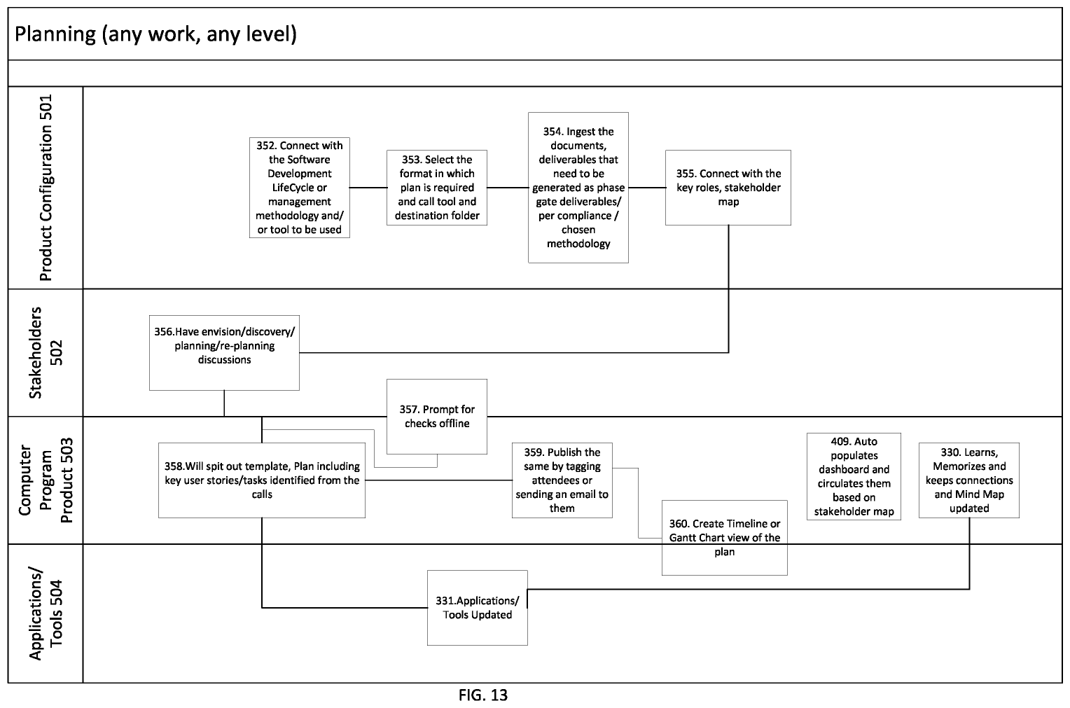

FIG. 14 is a lane diagram showing a preferred embodiment of a method for tracking. The product configuration lane 501 shows the following steps: 361 connecting with the plan; 362 connecting with a communication application (e.g., an email set up or workspace tool that is being used to communicate; and 363 connecting with stakeholder map. The stakeholders lane 502 shows the following steps: 364 updating statuses (e.g., by calling out blockers or asking for statuses); and 365 updating or modifying plan as needed offline. The computer program product lane 503 shows the steps of 366 creating or updating action items, risks, and issues where results vary from pan and updating items and tasks in a plan in terms of status, and sharing updates where tool has latest updates; 367 updating tasks status, for example, in terms of percentage of tasks done over time; 368 showing updated actual versus planned roadmap view; and 330 learning, memorizing, maintaining connections, and maintaining the mind map. The applications/tools lane 504 includes the following step: 333 updating applications and tools.

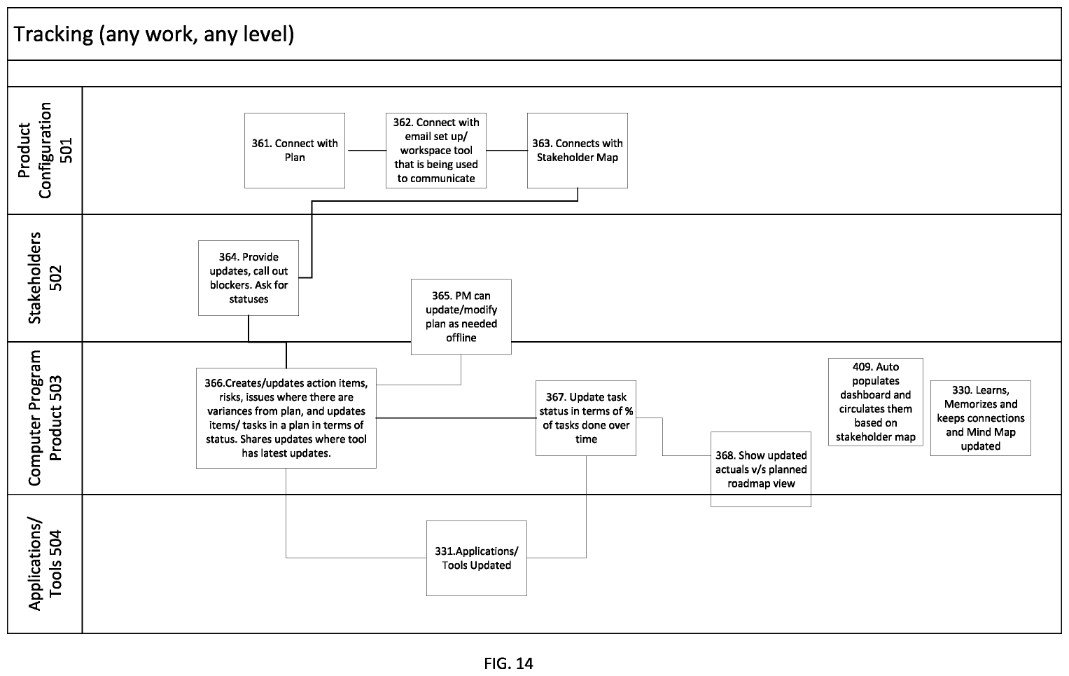

FIG. 15 is a lane diagram showing a preferred embodiment of a method for scope management and capture. The product configuration lane 501 show the steps of 369 integrating with a user story or requirements tool; and 370 creating or updating provided templates of user stories based on trend. The stakeholders lane 502 shows the steps of 371 inputting scope, context, problems, roadmap, backlog items, user stories, story points, tasks, and hours to be input; and 372 calling out key words like story points, user story, description, effort, user story descriptions, scope, mockups, attach documents, dependence, backlog, and wish list. The computer program product lane 503 shows the steps of 373 listening to call and captures of the user story, epic, features, outcomes and other details in the relevant sections; 374 checking content and placement with users offline; 375 recalling the content on demand; 330 learning, memorizing, maintaining connections, and maintaining the mind map; and 376 providing recommendations from learnings from similar scope items. The applications/tool lane 504 show the step of 331 updating applications and tools.

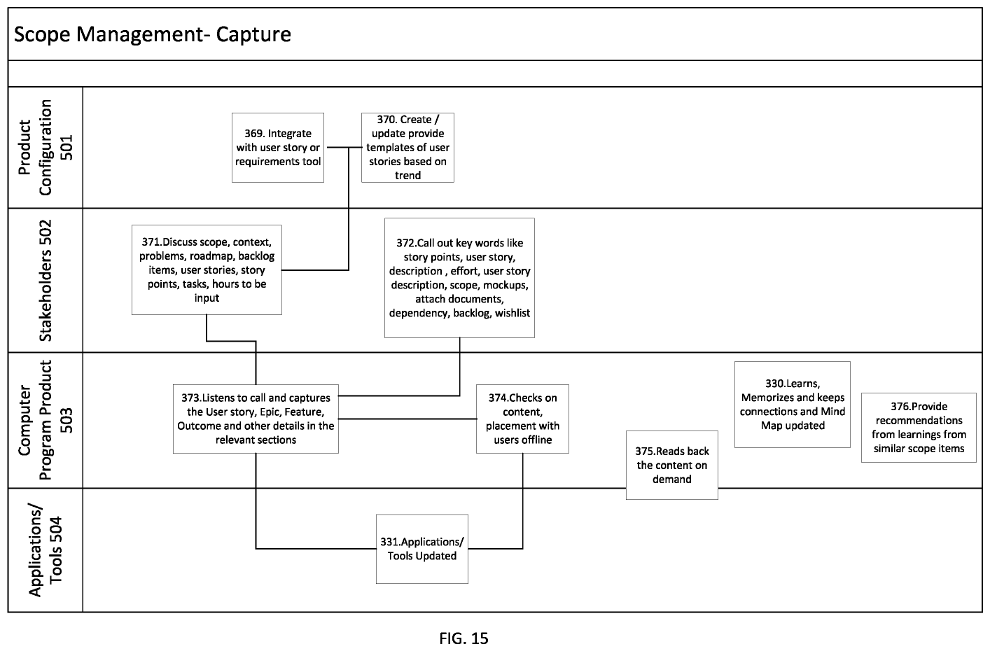

FIG. 16 is a lane diagram showing a preferred embodiment of a scope management and tracking. The product configuration lane 501 shows the step of 377 integrating with user story or requirements tool. The stakeholders lane 502 shows the step of 378 discussing scope related information around timing, effort, and assignees; 379 checking task status (e.g., what's done, what's to be done, and obstacles on daily stand ups; and 380 calling out key words like story points, effort, work description, and attaching documents. The computer program product lane 503 shows the steps of 381 creating and updating the scope in terms of timing, task created, tasks, assignees, hours and other discussed details; 382 tracking or updating dependent tasks and dependency map with dependencies captures during calls; checking offline for status updates, acceptance criteria, effort, time, and releases, etc.; 375 reading back the content on demand; and 330 learning, memorizing, and updating connections and min maps. The applications and tools method lane diagram 504 shows the method step of 331 updating applications and tools.

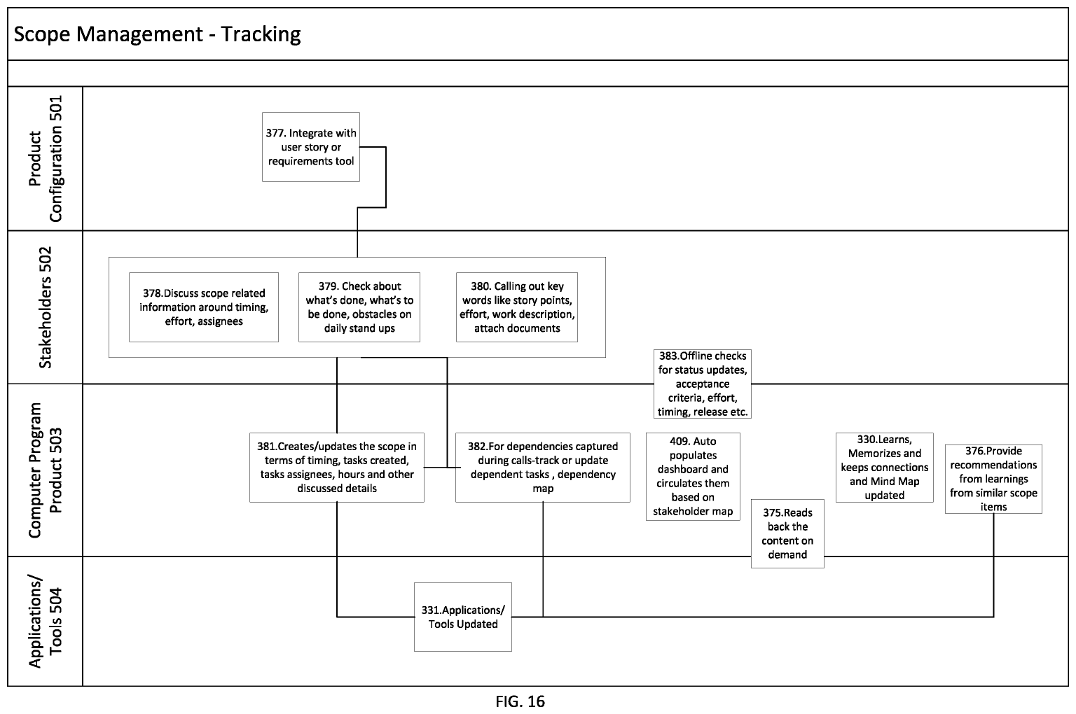

FIG. 17 is a lane diagram showing a preferred embodiment of a method for tracking architecture and security management. The product configuration lane 501 shows the step of 450 integrating with a relevant tool. The stakeholders lane shows the steps of 451 discussing architecture, security, compliance recommendations; 452 referring to standards housed in enterprise tools; and 453 calling out key words like penetration tests and security development reviews. The computer product lane 503 shows the steps of 454 creating and updating the tasks, assignees, hours, and other discussed details against relevant epics, initiatives, projects, tasks, and story; 455 tagging tasks for show stoppers; 375 reading back the content on demand; 330 learning, memorizing, and keeping connections and mind map updated; and 376 providing recommendations from learning from similar scope items. The applications and tools lane 504 shows the step of 331 updating applications and tools.

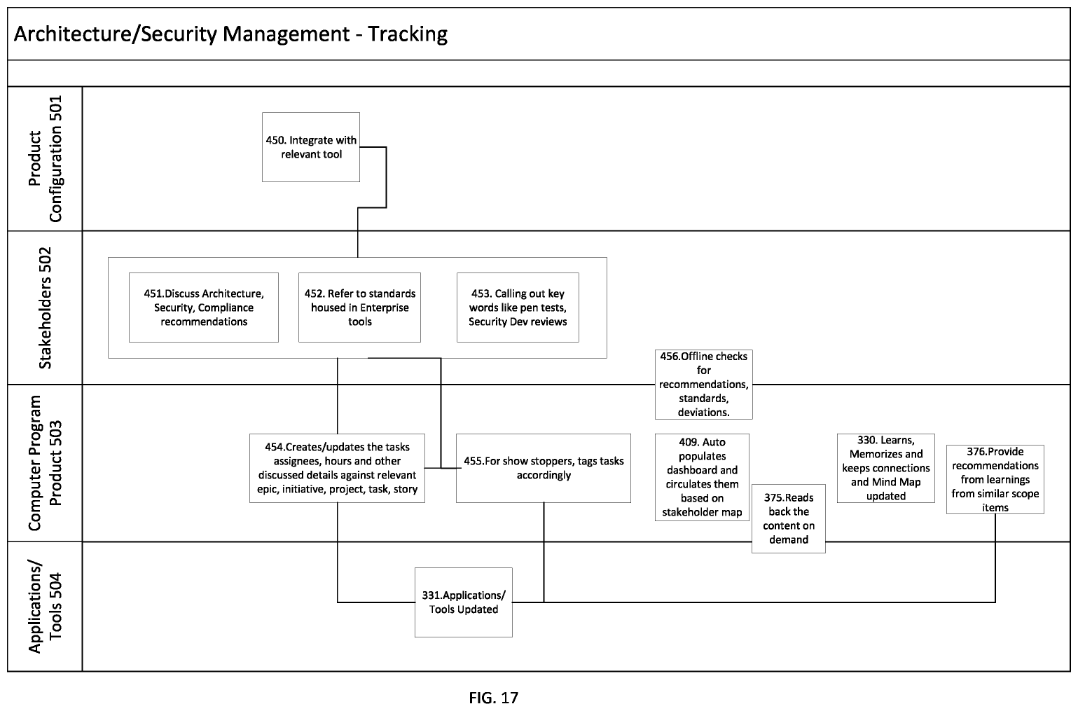

FIG. 18 shows an automation lane diagram. The product configuration lane 501 shows the step of 457 identifying all tools needed, frequency, users, and mode of communication. The stakeholders lane 502 shows the steps of 458 performing a sequence of actions; 459 calling a sequence of steps; and 460 calling out key words to name the automation, like planning, architecture, etc. The computer program product lane 503 shows the steps of 461 creating the automation and executing it; 382A sending alerts and follow ups for manual overrides; 383 offline checking for updates of the process; 330 learning, memorizing, and keeping connections and mind map updated; and 376 providing recommendations from learning from similar scope items. The applications and tools lane 504 show step 331 updating the applications and tools.

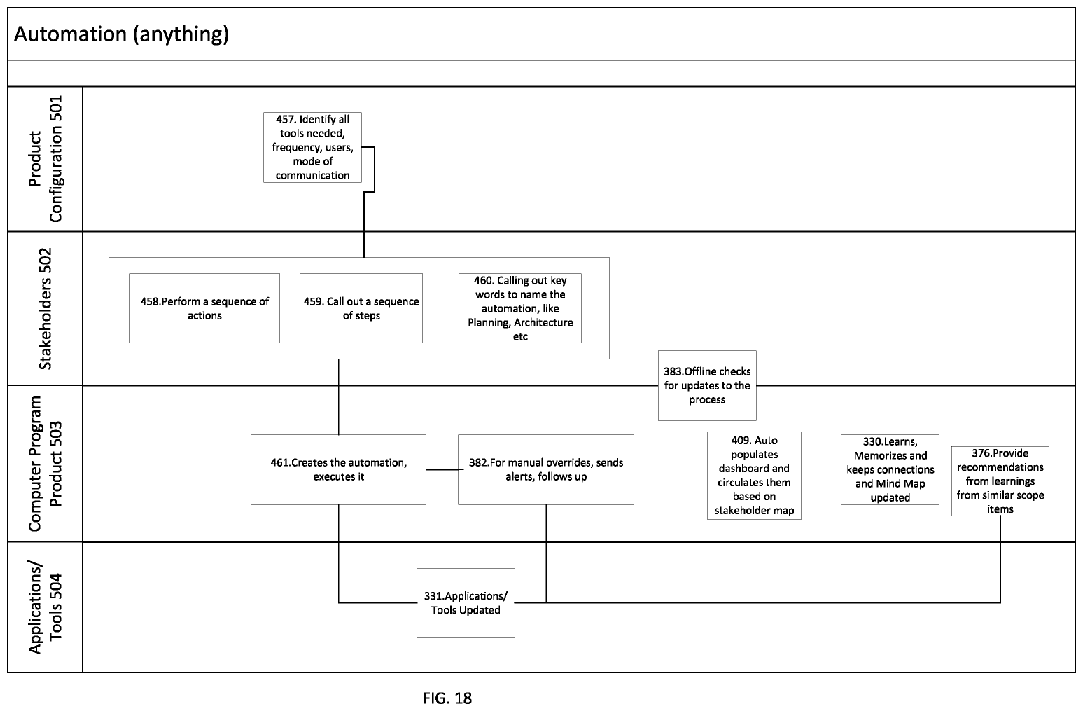

FIG. 19 is a lane diagram illustrating a preferred embodiment of a method for resource management. The product configuration lane 501 shows the step of 384 integrating with human resource or people management tool or outlook or PM tool; 385 choosing standard templates, views, and graphs for resource demand and supply management; 386 connecting with the resources and project assigned information. The stakeholders lane 502 shows the following steps: 387 using chosen views to see or ask about availability allocation; 388 requesting resources over a call providing role, percentage, start date, end date, and skill set; 389 releasing resources over the call due to the end of project, scope change, or budget situation; 390 asking if a project can be done at the current or future time; and 391 asking for resources, roles, and skill level information. The computer program product lane 503 shows the steps of 392 interpreting the query results and checking resource availability of assignments and providing information, summary, recommendations as response back in voice or chat; 393 listening and recording release information, roles, rates, skills, and hierarchy for resources; 394 talking back to creator, asking for project status and possibility to combine resource needs with other projects; 330 learning, memorizing, and keeping connections and mind map updated; 376 providing recommendations from learning from similar scope items; and 396 auto updating resource pool post onboarding, assigning of new resources, releasing an existing resources on offboarding; 330 learning, memorizing, and keeping connections and mind map updated; 376 providing recommendations from learning from similar scope items; and 396 auto updating resource pool post onboarding, assigning new resources, and releasing an exiting resource on offboarding. The application and tools lane 504 show the step of 331 updating the applications and tools.

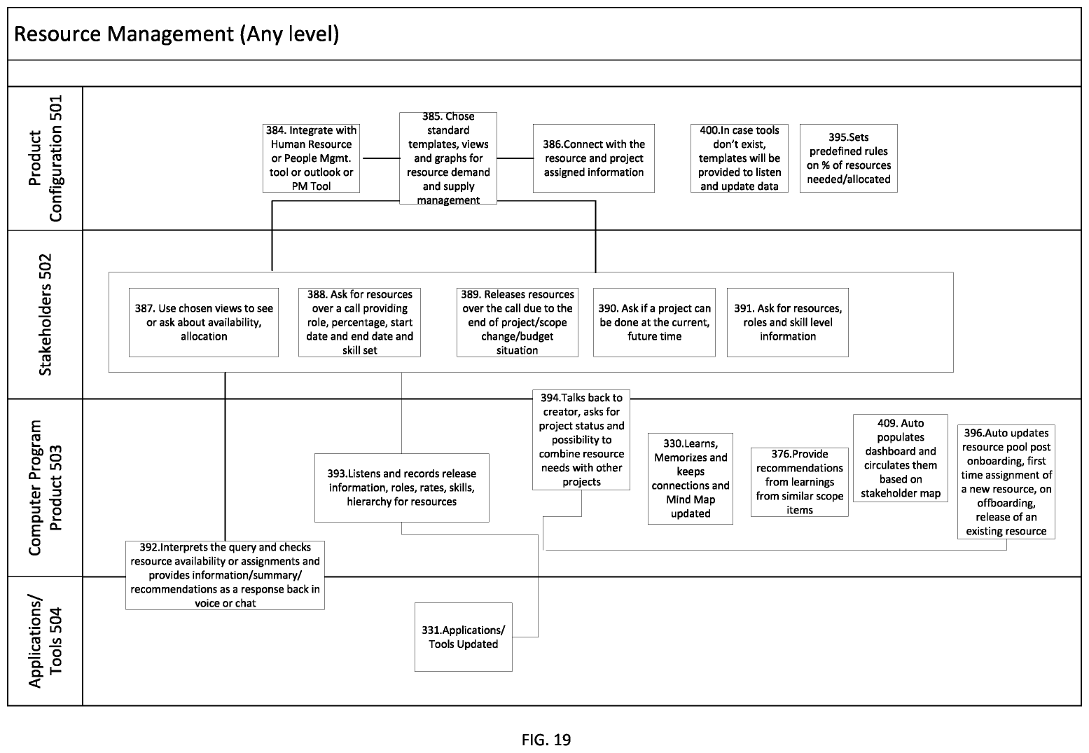

FIG. 20 is a lane diagram showing a method for generating 6 P Status. The product configuration lane 501 shows the following steps: 397 integrating with PM tool, scope management tool, and financial management tool; 398 choosing portfolio dashboard views; 399 integrating with distribution lists including escalation lists for people in workspace tool and setting frequency; and 400 providing template to listen and update data if case tools do not exist. The stakeholders lane 501 shows the following steps: 401 searching for update of required information tool data including completion date, delay, risks, issues, and deployment date; 402 asking for status of recommendation for an initiative; 403 requesting for time dashboard generation; and 404 requesting delivery feasibility, predictability, possible timelines for a new initiative. The computer program product lane 503 shows the following method steps: 405 crawling through the tools to generate the chosen dashboard view; 406 sharing risks, issues, and changes in a project with an escalation list; 407 responding to status update requests; 408 gauging status, risks, and issues based on scope and financial management; 409 auto populating a dashboard and circulating the dashboard on stakeholder maps; 330 learning, memorizing, keeping connections and mind map updated; and 410 making recommendations based on historical data. The application tools lane 504 shows the method step of 331 updating applications and tools.

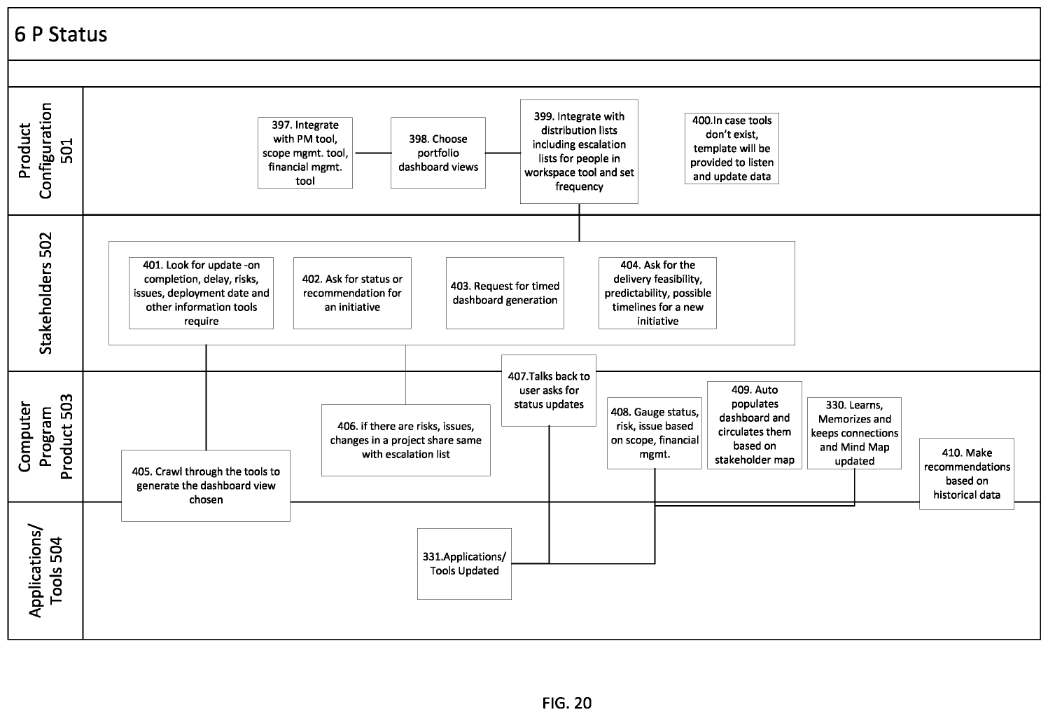

FIG. 21 is a lane diagram illustrating a preferred embodiment of a method for financial management. The product configuration lane 501 shows the following steps: 411 integrating with PM tool, financial management tool, and timesheet tool; 412 choosing financial management report/dashboard templates; 413 integrating with distribution lists including escalation lists for people in out or other workspace tool; and 400 providing templates to receive and update data if case tools do not exist. The stakeholders lane 502 shows the following steps: 414 requesting financial information (e.g., actuals, forecast, dashboard, benefits, capex, opex) or variance alerts; 415 requesting for financial recommendation (feasibility, predictability, spending profile, cost benefit analysis, and priority; 416 providing actual cost, timesheet input. The computer program product lane 503 shows the following steps: 417 marking variances from projections and checking on changes, risk issues to see if the same can be justified; and generating notifications as configured; correcting timesheets; 418 updating financials after executing approval workflow; 419 auto populating dashboards and circulating them based on stakeholder map; 330 learning, memorizing, and keeping connections and mind map updated and 410 making recommendations based on historical data. The applications/tools lane 504 show step 331 updating applications and tools.

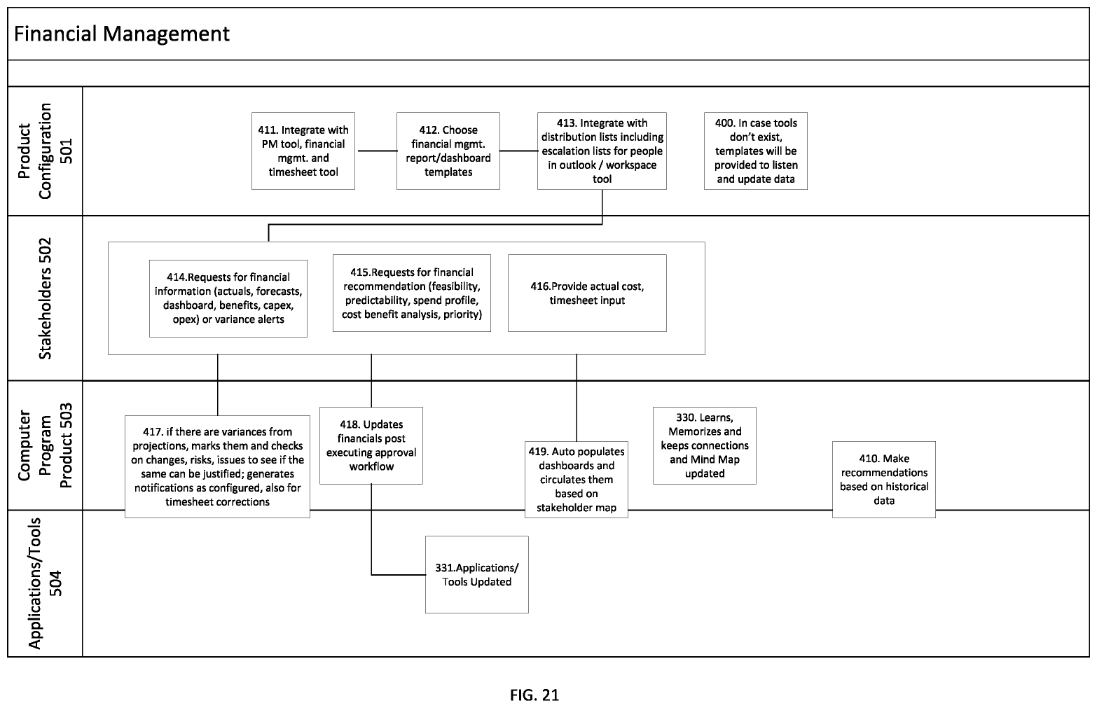

FIG. 22 is a lane diagram showing a preferred embodiment of a method for incident, problem, and release management. The product configuration lane 501 includes the following steps: 420 integrating with the POM tool, scope, LC-CD incident, and release management tools; 421 showcasing incident, release management reports, and dashboard templates; 422 integrating with distribution lists including escalation lists for people in outlook or other workspace tools. The stakeholders lane 502 shows step 423 requesting information from the tool with a verbal trigger or predefined frequency or threshold for generating dashboards. The computer program product lane 503 shows the following steps: 424 crawling through the tools to generate the dashboard view chosen; 425 prompting predefined user to take action incidents by alerting verbally or sending notification; 426 suggesting release dates based on common code components impacted; 427 auto creating incident and release reports with no human intervention; and 429 creating problem management records based on incidents and taking action in environment based on preapproval. The applications and tools lane 504 shows the step of 331 updating applications and tools.

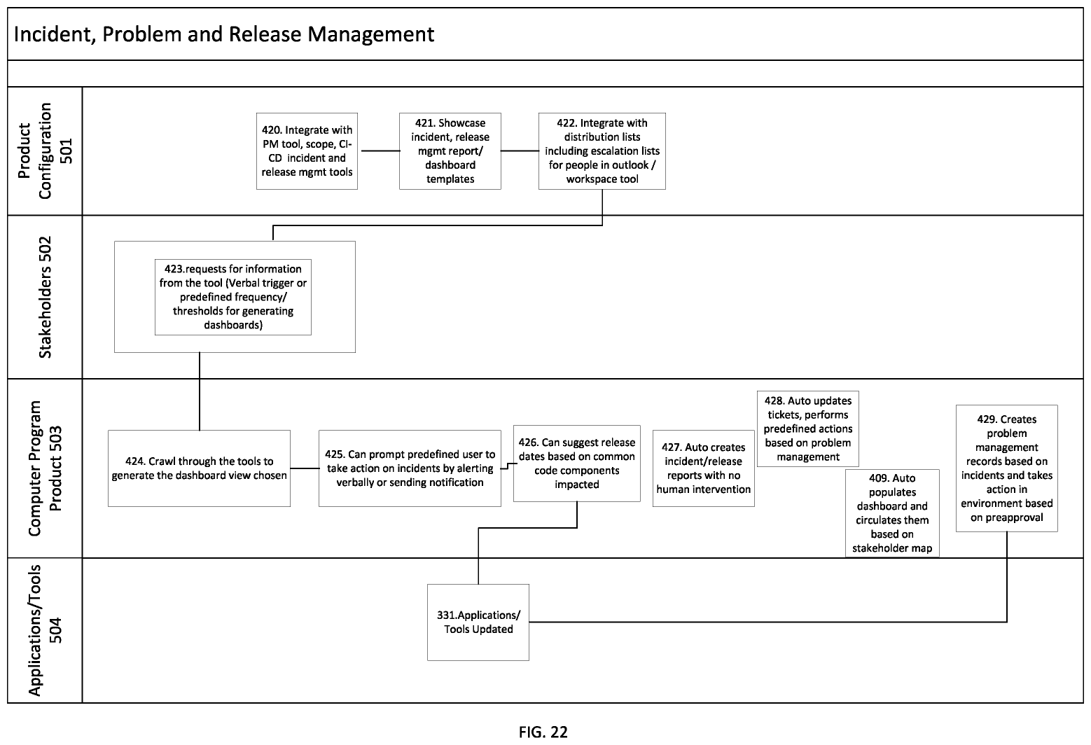

FIG. 23 is a lane diagram showing a preferred embodiment of a method for generating management presentations, dashboards, and reports (PDR). The product configuration lane 501 shows the following steps: 430 setting up on device where PDR are created and generated; 431 providing any document inventories where PDR are available for reference. The stakeholders lane 502 shows the following steps: 432 creating and updating PDR on a call and discuss content; and 433 calling out keywords (e.g., highlights, as-is, gaps, to-be, goals, vision, strategy, financials, prioritization, etc.) and invoking the right set of PDR. The computer program products lane 503 shows the following steps: 434 creating slides based on previous content, current discussion, and connecting tool data; 435 talking back to creator, taking suggestions, and making changes in text and look and feel; 436 reading back the contents on demand; 437 making recommendations based on historical data; and 330 learning, memorizing, and keeping connections and mind map updated. The applications and tools lane 504 show the step 331 updating applications and tools.

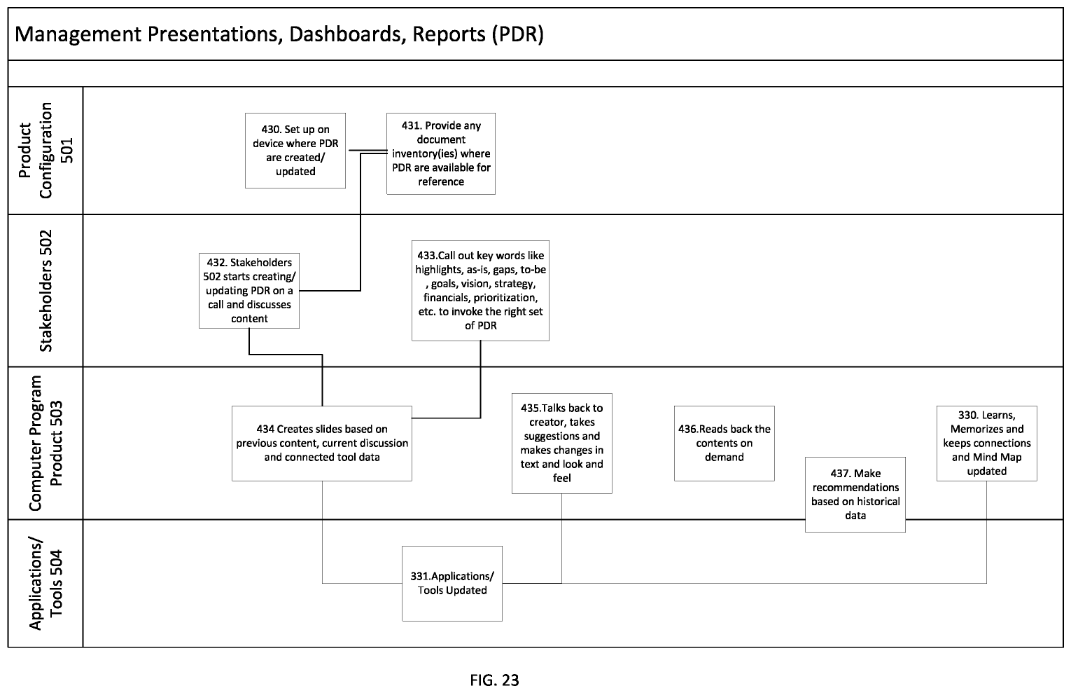

FIG. 24 is a lane diagram showing a preferred embodiment of a method for generating management drawings. The product configuration lane 501 shows the following steps: 438 setting up on device where drawings are required; and 439 providing and repository or workspace information where drawings are saved to reference. The stakeholders lane 502 shows the following steps: 440 starting creation of presentation on a call and discussing content; and 441 calling out keywords like creating/updating flowcharts, highlights, as-is, gaps, to-be, goas, vision to invoke the right set of flowcharts. The computer program product lane 503 shows the following steps: 442 creating diagrams based on previous content, current discussions, and connected tool data; 443 talking back to creator, taking suggestions, and making changes in text, look and feel, and placement; 436 reading back the content on demand; 437 making recommendations based on historical data; and 330 learning, memorizing, and keeping connections and mind map updated. The applications and tools lane 504 shows the step of 331 updating applications and tools.

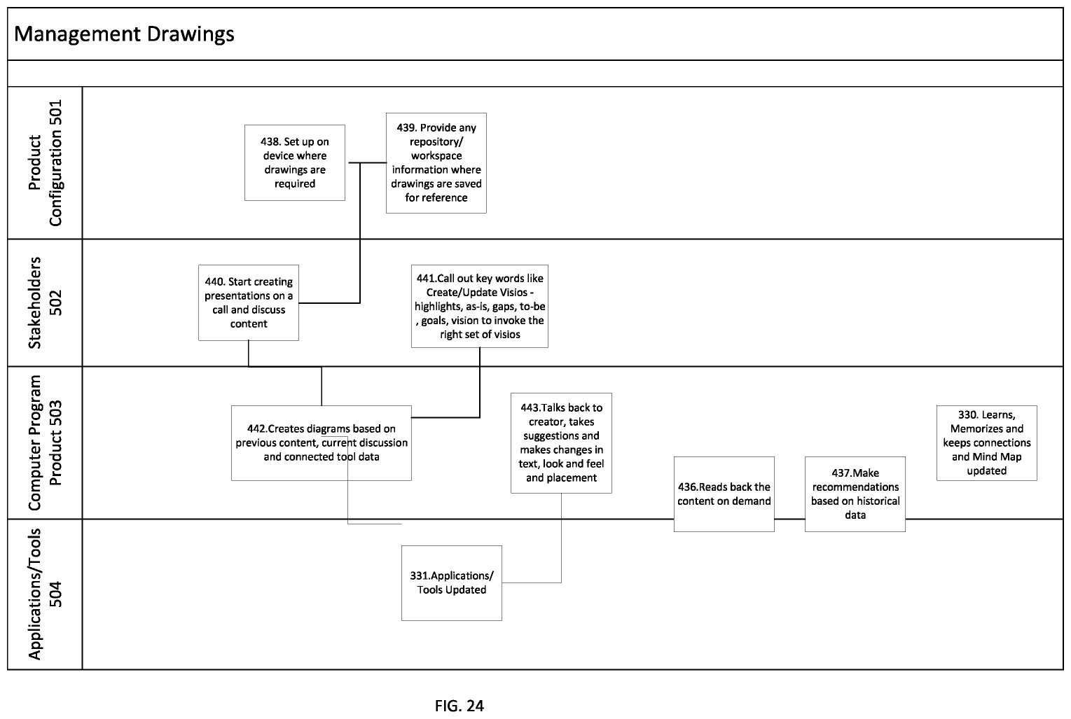

FIG. 25 is a lane diagram showing a preferred embodiment of a method for generating management documents. The product configuration lane 501 shows the following steps: 444 setting up on device where documents are required; and 445 providing any or workspace information where docs are saved for reference. The stakeholders lane 502 shows the following steps: 446 creating documents on a call and discussing content; and 447 calling out keywords like creating and updating highlights, as-is, gaps, to-be, goals, vision, etc. The computer program product lane 503 shows the following steps: 448 capturing the spoken words in the documents, basing on the words spoke or being input, placing in the right section of a template, and finding similar documents; 449 talking back to creator, taking suggestions, and making changes in text and placement; 436 reading back the content on demand; and 437 making recommendations based on historical data. The applications and tools lane 504 show the step of 331 updating applications and tools.

The functionalities and capabilities are not limited to the use cases shown in the lane diagrams.

Computer

Embodiments of the present systems and techniques, and all the functional operations described in this specification can be implemented in digital electronic circuitry, or in computer software, firmware, or hardware, including the structures disclosed in this specification and their structural equivalents, or in combinations of them. Embodiments of the present systems and techniques can be implemented as one or more computer program products, i.e., one or more modules of computer program instructions encoded on a computer readable medium for execution by, or to control the operation of data processing apparatus. The computer readable medium can be a machine readable device, e.g., a machine-readable storage device, storage medium, or memory device, or multiple ones thereof. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile phone, a personal digital assistant (PDA), a wearable device, augmented virtual reality devices, a mobile audio player, a Global Positioning System (GPS) receiver, to name just a few. Information carriers suitable for storing computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the present systems and techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the present systems and techniques can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the present systems and techniques, or any combination of such back-end, middleware, or front-end components. The components of the system can be interconnected by any form or medium of digital data communication, e.g., a communication network. Examples of communication networks include a local area network (“LAN”), a wide area network (“WAN”) and a network of networks, e.g., the Internet.

The computing system can include clients and servers. A client and server are generally remote from each other and typically interact through a communication network. The relationship of client and server arises by virtue of computer programs running on the respective computers and having a client-server relationship to each other. Servers can be physical, virtual or in the Cloud, as needed

Particular embodiments of the present systems and techniques have been described. Other embodiments are within the scope of the following claims. For example, the actions recited in the claims can be performed in a different order and still achieve desirable results, and an online analysis system (as described) can include all the operational features described above or just a proper subset of them. The user interface functionality described can be implemented in a browser toolbar (e.g., for Internet Explorer available from Microsoft of Redmond, Wash.) in which one can do direct buzz searches on a technology universe and receive browser toolbar notification of any new novel terms found in the technology universe. Moreover, the system can be implemented with multiple computers on a network such that different computers perform different parts of the online analysis scraping, indexing, calculation, user interaction, and presentation. Different parts of the system can be more mobile than others; for example, the user interaction or presentation could be handled by mobile phones, Virtual Reality Assistants, Personal Digital Assistants (PDAs), handheld gaming systems, or other portable devices.

Hardware and Software

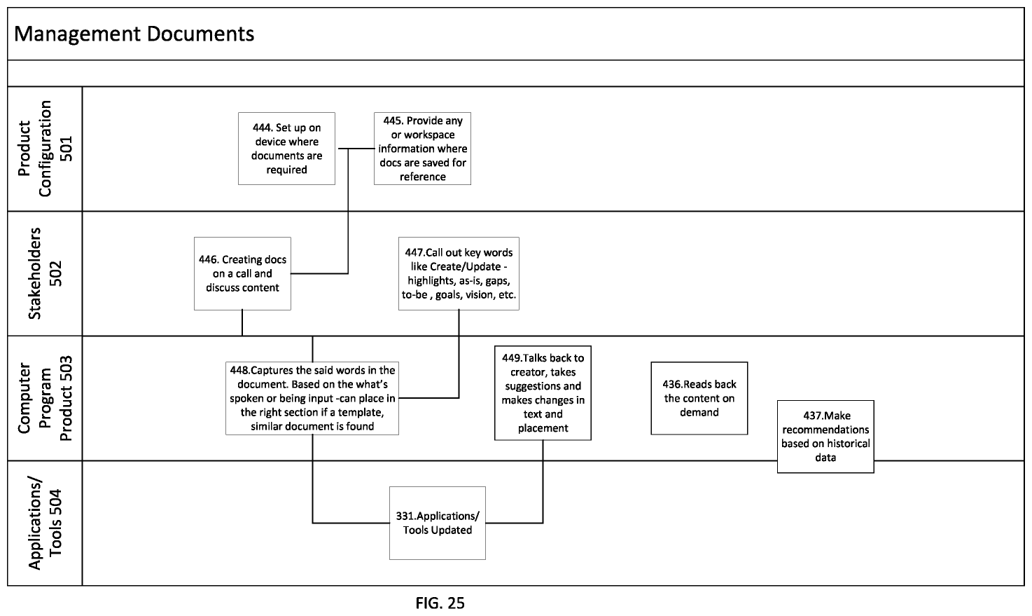

As noted above, certain aspects of the present invention may be executed by or with the help of a general-purpose computer. The phrases “general purpose computer,” “computer,” and the like, as used herein, refer but are not limited to an engineering workstation, PC, Macintosh, PDA, web-enabled cellular phone, and the like running an operating system such as OS X, Linux, Windows CE, Windows XP, Symbian OS, or the like. The phrases “General purpose computer,” “computer,” and the like also refer, but are not limited to, one or more processors operatively connected to one or more memory or storage units, wherein the memory or storage may contain data, algorithms, and/or program code, and the processor or processors may execute the program code and/or manipulate the program code, data, and/or algorithms. Accordingly, exemplary computer 10000 as shown in FIG. 26 includes system bus 10050 which operatively connects two processors 10051 and 10052, random access memory (RAM) 10053, read-only memory (ROM) 10055, input output (I/O) interfaces 10057 and 10058, storage interface 10059, and display interface 10061. Storage interface 10059 in turn connects to mass storage 10063. Each of I/O interfaces 10057 and 10058 may be an Ethernet, IEEE 1394, IEEE 802.11, or other interface such as is known in the art. Mass storage 10063 may be a hard drive, optical disk, or the like. Processors 10057 and 10058 may each be a commonly known processor such as an IBM or Motorola PowerPC or an Intel Pentium.

Computer 10000 as shown in this example also includes an LCD display unit 10001, a keyboard 10002 and a mouse 10003. In alternate embodiments, keyboard 10002 and/or mouse 10003 might be replaced with a pen interface. Computer 10000 may additionally include or be attached to card readers, DVD drives, or floppy disk drives whereby media containing program code may be inserted for the purpose of loading the code onto the computer.

In accordance with the present invention, computer 10000 may be programmed using a language such as Java, Objective C, python, C, C #, or C++ or open source languages according to methods known in the art to perform the software operations described above. In certain embodiments DRM containers such as DRM vaults may be implemented using Intertrust Digibox Containers, while the DRM-V software may employ the functionality of an Intertrust InterRights Point.

In certain embodiments, although the message set order protocols and datasets described herein may be closed and proprietary, the application protocol interfaces (APIs) for interfacing with them may be published and provided as open standards.

### RAMIFICATIONS AND SCOPE

Although the description above contains many specifics, these are merely provided to illustrate the invention and should not be construed as limitations of the invention's scope. Thus, it will be apparent to those skilled in the art that various modifications and variations can be made in the system and processes of the present invention without departing from the spirit or scope of the invention.

What is claimed is:

1. A method for updating application data based on user device output, which comprises:
providing a receptor/interface for receiving user device output;
connecting a core to said computer, said core hosting an artificial neural network;
connecting a computer hosting a software tool to said core, said tool storing application data;
monitoring a relationship between an initial reception of said user device output and a change to said application data with said artificial neural network;
transmitting a subsequent reception of said user device output received by said receptor/interface to said artificial neural network;
transmitting an instruction from said artificial neural network to said software tool to enter said change to said application data after said artificial neural network decides said user device output is relevant; and
entering said change to said application data with said software tool when said software tool receives said instruction from said artificial neural network.

2. The method according to claim 1, wherein said user device output is chat text.

3. The method according to claim 1, wherein said user device output is computer input.

4. The method according to claim 1, wherein said user device output is an audio capture.

5. The method according to claim 1, wherein said user device output is an online meeting recording.

6. The method according to claim 1, wherein said user device output is virtual reality device data.

7. The method according to claim 1, wherein said software tool is project management software and said application data describes a task of a project.

8. The method according to claim 7, which further comprises reporting said change to said application data to a manager of said project.

9. The method according to claim 8, which further comprises:
deleting said change to said application data when said manager decides to override said artificial neural network;
transmitting data describing a decision by said manager to override said artificial neural network to said artificial neural network; and
changing said artificial neural network when said artificial neural network receives said data describing said decision by said manager.

10. The method according to claim 7, which further comprises:
transmitting said application data to said artificial neural network after changing said application data; and
reporting to said manager when said artificial neural network determines said application data violates a requirement of said project.

11. The method according to claim 10, wherein said artificial neural network creates said requirement based on a requirement found by sad artificial neural network in prior projects analyzed by said artificial neural network.
